(19) United States
(12) Patent Application Publication
(10) Pub. No.: US 2010/0167232 A1
(43) Pub. Date: Jul. 1, 2010

(54) ENDODONTIC DEVICE

(76) Inventor: Ajit Karmaker, Wallingford, CT (US)

Correspondence Address: CANTOR COLBURN LLP, 20 Church Street, 22nd Floor, Hartford, CT, 06103-3207, US

(21) Appl. No.: 11/933,683

(22) Filed: Nov. 1, 2007

(51) Int. Cl. A61C 5/02; A61C 13/38

(52) U.S. Cl. 433/81; 427/2.29

(57) ABSTRACT

An endodontic obturator is provided having a carrier that is fabricated of a material capable of being molded into very fine dimensions and also being easily removable from the root canal.

### TECHNICAL FIELD

This invention relates to endodontic materials and more specifically, to obturators for root canal treatments.

### BRIEF DESCRIPTION OF THE RELATED ART

Endodontics or root canal therapy is that branch of dentistry that deals with the diseases of the dental pulp and associated tissues. One aspect of endodontics comprises the treatment of infected root canals, the removal of diseased pulp tissues, followed by the biomechanical modification and the subsequent filling of the pulp cavity (root canal). Root canal therapy is generally indicated for teeth having sound external structures but having diseased, dead or dying pulp tissues. Such teeth may or may not generally possess intact enamel and dentin and are satisfactorily engaged with bony tissue in such teeth, the pulp tissue and excised portions of the root should be replaced by a biocompatible substitute.

One technique for the preparation of a root canal involves creating a coronal access opening with a conventional dental drill. A tool is used for gross removal of pulp material from the root canal through the coronal access opening. The void formed is enlarged with reamers and/or files to result in a fully excavated cavity. Debris is removed from this cavity by flushing and the cavity is cleansed to remove all diseased tissue. This process, while essential, results in a root canal that is weakened and susceptible to fracture. Following chemical antisepsis, the excavated canal is ready for filling.

A basic method involves inserting a filling cone into a root canal and cementing therein to obturate the canal. The common root canal filling cone material is made from gutta-percha. Lateral condensation is a method in which several filling cones, a primary cone and auxiliary cones, are inserted into a root canal. The primary cone is inserted and cemented to the seat of the root canal. Using a tapered spreader, the primary cone is then squeezed against the side of the root canal and a second cone is inserted and cemented into place. This process is continued until the root canal is completely obturated which can require up to 10 to 15 filling cones. Vertical condensation of warm or hot gutta-percha is yet another method of sealing root canals. After cementing a primary cone short of the apex of the root canal, heat application is alternated with a series of smaller and smaller pluggers until the gutta-percha is moved to the apex. This is often possible when the smallest plugger approaches the apex of the tooth within 3 to 5 millimeters. The space is then backfilled. Lateral canals are packed and sealed as a consequence of lateral expansion of a wave of heated gutta-percha. Alternatively, small segments of gutta-percha can be used in this method that are inserted into the root canal, heated in order that they can adhere to one another and each backfilled one at a time until the root canal is filled. All three of these methods, the single filling cone, lateral condensation and vertical condensation apply root canal cement or sealer around the individual cones or in between segments as a binding agent.

Another method employs an injection gun that injects warm or hot gutta-percha filling material into a root canal. The injector initially places heated gutta-percha at the apical area of the root canal through a needle-like canula tip and fills the gutta-percha into any surrounding voids/spaces under pressure or at the seat of the root canal which is then condensed with a plugger into the root tip. The injector then backfills the root canal by injecting additional gutta-percha into the root canal until it is obturated. A similar method involves heating gutta-percha on a flexible metal or plastic carrier used to insert the gutta-percha into the root canal. The carrier may be a solid rod, or a hollow rod, situated in the center of a master cone. The rod is connected to a handle which may be removed by slipping it out of the hollow rod, or cutting it off if it is a solid rod.

The carrier comes in a variety of sizes to fit to the various sizes of patients' root canals that are not uniform in size. Typically, carriers are provided in a range of different sizes corresponding to standard endodontic files, which files are used to clean and prepare the canal prior to insertion of filling material. In order to accommodate all sizes of root canals, carriers must be as small as 0.10 mm in diameter. The smaller size carriers must have enough strength and integrity to carry the filling material and also be able to navigate the root canal.

U.S. Pat. Nos. 5,118,297, 5,588,835, 7,211,136, 7,204,875 7,204,874 and U.S. Published Application Nos. 20070184405 and 200700317494 teach root canal filling materials and obturators and are hereby incorporated by reference. U.S. Pat. No. 5,118,297 teaches the use of polysulfone and liquid crystal polymer as useful materials for the carrier body. Polysulfone is difficult to injection mold into very fine sizes. Although liquid crystal polymer is moldable into very fine sizes, it is not easily removable with root canal solvents. None of the prior art teaches obturators fabricated of materials that are easily moldable into very fine sizes and that are also easily removable with root canal solvents.

It is desirable to provide a carrier for root canal filling materials that is available in a broad range of sizes. It is preferable that the carriers have strength and integrity to carry filling material and withstand insertion into the root canal, but which are also flexible to follow the curvature of the root canal. It would be beneficial if the carrier could be dissolved and/or easily removed. It would be advantageous to be able to use the same carrier material in the manufacture of all obturator sizes.

### SUMMARY OF THE INVENTION

These and other objects and advantages are accomplished by an endodontic device for filling root canals having a carrier that is moldable in all required obturator sizes including very fine sizes and is also easily removable from the root canal.

Specifically, in one embodiment, the carrier comprises a thermoplastic matrix material, a filler and a process aid. The addition of the process aid provides flowability to render the matrix-filler combination easily moldable.

In a method of making the carrier, a thermoplastic matrix material, a filler and a process aid are compounded and injection molded into a carrier.

### BRIEF DESCRIPTION OF THE DRAWINGS

Features of the present invention are disclosed in the accompanying drawing wherein:

FIG. 1 is an elevational view of an obturator having a filling material thereon.

### DETAILED DESCRIPTION OF THE PREFERRED EMBODIMENTS

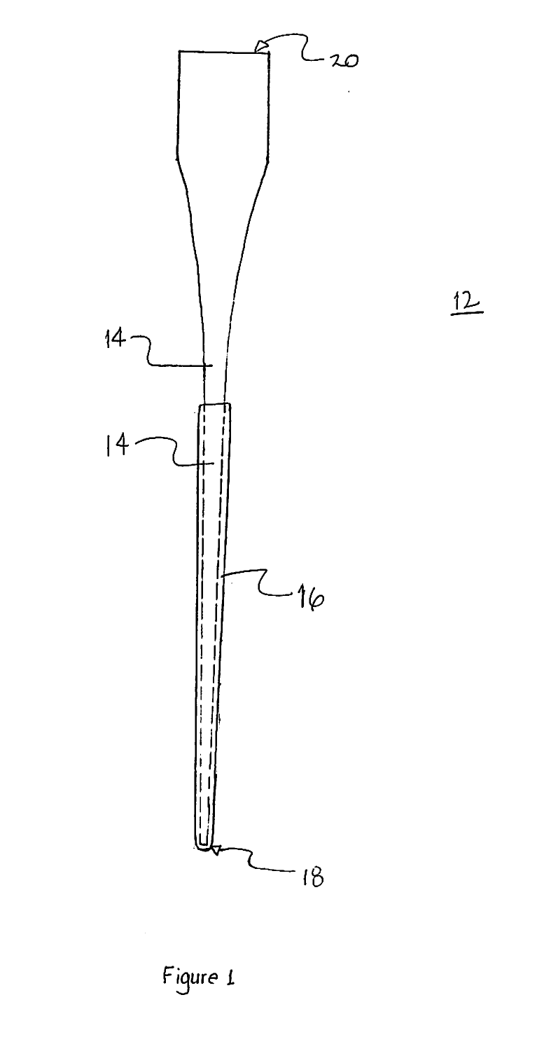

As will be appreciated, the present invention provides the dentist or endodontist with a root canal filling device for easily and effectively performing the initial treatment and managing the ongoing care of problems associated with the roots of teeth. Reference is made to FIG. 1 that shows an obturator 12 having a shaft 14 and a filling material 16 disposed thereon. Obturator 12 has a distal end and a proximal end 20. The distal end 18 is the tip or apical end of obturator 12 and the proximal end 20 is the coronal end or handle.

Obturator 12 is fabricated of a material that may be easily removed from a root canal. In order to be easily removable from a root canal, it is preferable that the obturator is fabricated of a material that is easily dissolvable, either partially or fully, in a dental or root canal solvent, and can thereby be easily removable from the patient's root canal, if necessary.

Useful materials for the shaft 14 of obturator 12 are thermoplastic materials in combination with fillers, whereby the fillers provide strength and integrity to the thermoplastic matrix and the thermoplastic matrix provides flexibility for following the curvature of the canal.

Thermoplastic materials useful herein include, but are not limited to, polyamides, polyesters, polyimides, polyarylates, polyurethanes, polysulfones, polyacetals, polycarbonates, polyphenylene sulfides, polyphenylenes, polyarylsulfides, polyketones, polyphthalamides or mixtures thereof.

It is preferable that the thermoplastic matrix material have an injection molding temperature equal to or greater than about 300° C., and preferably equal to or greater than about 330° C. Furthermore, it is preferable that the thermoplastic matrix material have a melting temperature in the range from about 150° C. to about 200° C., more preferably in the range from about 160° C. to about 190° C., and most preferably in the range from about 170° C. to about 185° C. One preferable thermoplastic material useful herein is poly sulfone having an injection molding temperature in the range from about 330 to about 385° C. Commercially available polysulfones include UDEL P-3703 (melt flow of 17 g/10 min at 343° C. and 2.16 kg and molecular weight of 56,200), UDEL P-1700 (melt flow of 6.5 g/10 min at 343° C. and 2.16 kg and molecular weight of 66,000), available from Solvay Advanced Polymers, LLC, Alpharetta, Ga.

Fillers are well known in the art and can include, for example, apatites, silica glass fillers, calcium silicate based fillers, hydroxyapatites, barium sulfate, bismuth subcarbonate, bismuth oxychloride, ytterbium oxide, ytterbium fluoride, ytterbium iodine, bismuth oxide, bismuth trioxide, bismuth fluoride, barium oxide, tantalum oxide, zinc oxide and zirconium oxide. It is preferable that the filler is also radiopaque. A preferred filler is bismuth oxide.

The combination of thermoplastic materials with fillers renders it difficult to mold shaft 12 into the smaller-sized obturators. Fillers increase the viscosity and reduce the melt flow. Without being bound to any theory, the inventor herein has found that the addition of process aids, also known as lubricants, to the thermoplastic matrix-filler combination improves flowability, allowing for the molding of finely-sized carrier shafts.

Suitable process aids are flowability aids or lubricants that reduce the cohesive forces between the molecular chains of the polymers, reduce the viscosity and increase the flowability of the mixture. Examples include fatty acids, fatty alcohols, wax esters, glycerol esters, glycol esters, phosphate esters, hydrocarbon waxes, fatty glycerides, unsaturated hydrocarbons, or a mixture thereof. An example of a commercially available process aid useful herein is INT-38H available from Axel Plastics Research Laboratories, Inc., Woodside, N.Y., which is a mixture of fatty acids, esters and glycerides.

It is preferable that the thermoplastic resin, filler and process aid are present in amounts of 50 to 80 percent by weight thermoplastic resin, 20 to 40 percent by weight filler, and 0.2 to 3 percent by weight process aid, and more preferably 55 to 75 percent by weight thermoplastic resin, 25 to 40 percent by weight filler, and 0.5 to 2 percent by weight process aid, and most preferably 60 to 70 percent by weight thermoplastic resin, 30 to 35 percent by weight filler, and 0.5 to 1.5 percent by weight process aid.

Optionally, other additives may be included in the mixture including, but not limited to, additional polymeric, resins, additional fillers, plasticizers and other additives typically used in dental tiller materials including, but not limited to, antibiotic, cariostatic, antibacterial, or other anti-inflammatory, biologically active, therapeutic materials, pigments and dyes. One preferred additional additive is a pigment, MPC Channel Black, produced by Keystone Aniline Corporation of Chicago. Ill., that provides a gray tint to the carrier shaft.

Examples of solvents useful herein for removing the obturator from the root canal include chloroform, tetrahydrofuran, benzene, acetone, toluene, dichloromethane, N-methyl-2-pyrrolidone, dimethyl sulfoxide, acetone, hexafluoroisopropanol, limonene, eucalyptus oil, xylene, chlorinated hydrocarbons, aromatic hydrocarbons, or a mixture thereof.

In the process of making the carrier herein, the thermoplastic material, filler and process aid are dry blended together. The thermoplastic material can be provided in the form of pellets. The process aid and tiller can be provided in powder form. The dry mixture is melted at a temperature in the range of about 285° C. to about 305° C., and preferably in the range from about 290° C. to about 300° C. and is extruded into a pellet. The pellet is then injection molded to form a carrier at a temperature in the range of about 335° C. to about 390° C., and more preferably in the range from about 360° C. to about 385° C.

After the carriers have been formed, filling material is applied thereon by any known means such as dipping, injection molding, hand rolling, and the like. The filling material is applied in an even consistent layer on the apical or tip end up toward the handle, covering almost the entire shaft area.

The filling material to be applied to the carrier can be a thermoplastic polymer, such as Epiphany® soft resin material available from Pentron Clinical Technologies, LLC, Wallingford, Conn. or Gutta-Percha available from Endodent, Inc. Duarte, Calif. Example of filling materials include gutta percha, polylactides, polyglycolides, polycaprolactones, polyanhydrides, polyamides, polyurethanes, polyesteramides, polyorthoesters, polydioxanones, polyacetals, polyketals, polycarbonates, polyorthocarbonates, polyphosphazenes, polyhydroxybutyrates, polyhydroxyvalerates, polyalkylene oxalates, polyalkylene succinates, polyethylene oxides, polyacrylates/methacrylates, poly(malic acid) polymers, polymaleic anhydrides, poly(methylvinyl)ethers, poly(amino acids), chitin, chitosan, and copolymers, terpolymers, or combinations or mixtures of the above materials and those materials taught in U.S. Pat. Nos. 5,118,297, 5,588,835, 7,211,136, 7,204,875 7,204,874 and U.S. Published Application Nos. 20070184405 and 200700317494, which are hereby incorporated by reference.

The filler material composition may include other polymeric resins, fillers, plasticizers and other additives typically used in dental filler materials including, but not limited to antibiotic, cariostatic, antibacterial, or other anti-inflammatory, biologically active, therapeutic materials, pigments and dyes.

The obturators range nominally in size with tip diameters as small as about 0.10 mm and as large as about 2.0 mm. The obturators taper in width from the tip/distal end and continue toward the coronal end to a point proximate the handle section of the obturator at rates including 0.01, 0.02 mm, 0.04 mm, 0.06 mm, 0.08 mm, and 0.10 mm.

The following non-limiting examples illustrate the invention.

### Examples

In this example, the melt flow of thermoplastic compositions was measured. The compositions tested are set forth in Table 1.

TABLE 1

| | Polysulfone | Bi203 | | Pigment Black 7 |
|---|---|---|---|---|
| | Udel- | MCP, NBS | Process aid | MPC Channel |
| | P3703 | grade | INT-38H | Black |
| Example 1 | 100.0 | | | |
| Example 2 | 64.2 | 35 | 0.5 | 0.3 |
| Example 3 | 64.2 | 35 | 0.5 | 0.3 |

In Example 1, the melt flow of polysulfone, by itself, was measured. In Examples 2 and 3, polysulfone was mixed with bismuth trioxide filler, a process aid and pigment. The melt flow of the mixture was measured. Table 2 set forth the melt flows of the compositions.

TABLE 2

| | Melt flow(g/10 min @ |
|---|---|
| | about 343° C. and 2.16 kg* |
| Example 1 | 17 |
| Example 2 | 28 |
| Example 3 | 29 |

*Measured by ASTM-D1238 test

As shown in Table 2, the melt flow increases with the addition of a process aid. One would expect that the melt flow number will drop with the addition of filler, but the addition of the process aid to the mixture increases the flow, even better than the number exhibited by an unfilled resin. Accordingly, it is preferable that the melt flow of the mixture of the thermoplastic material, filler and process aid as measured by the ASTM-D1238 test be greater than 20, and preferably greater than 25 g/10 min when measured at about 343° C. and 2.16 kg.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended embodiments.

What is claimed is:

1. An obturator for use in filling an endodontically prepared root canal comprising:
a shaft having a proximal end and a distal end; and
filling material disposed on the shaft;
wherein the shaft is made of a material comprising a thermoplastic matrix material, a filler, and a process aid;
wherein the thermoplastic matrix material has a molding temperature equal to or greater than about 300° C. and a melting temperature in the range from about 150° C. to about 200° C.; and.
wherein the shaft is dissolvable with a dental solvent.

2. The obturator of claim 1 wherein the diameter of the distal end of the shaft is in the range of about 0.15 mm to about 1.60 mm.

3. The obturator of claim 1 wherein the thermoplastic matrix material comprises polyamides, polyester, polyimides, polyarylates, polyurethanes, polysulfones, polyacetals, polycarbonates, polyphenylene sulfides, polyphenylene, polyarylsulfides, polyketones, polyphthalamide or mixtures thereof.

4. The obturator of claim 1 wherein the filler comprises one or more of apatites, silica glass fillers, calcium silicate based fillers, hydroxyapatites, barium sulfate, bismuth subcarbonate, bismuth oxychloride, ytterbium oxide, ytterbium fluoride, ytterbium iodine, bismuth oxide, bismuth trioxide, bismuth fluoride, barium oxide, tantalum oxide, zinc oxide and zirconium oxide.

5. The obturator of claim 1 wherein the process aid comprises a fatty acid, fatty alcohol, wax ester, glycerol ester, glycol ester, phosphate ester, hydrocarbon wax, fatty glyceride, unsaturated hydrocarbon, or a mixture thereof.

6. The obturator of claim 1 wherein the filling material comprises polylactides, polyglycolides, polycaprolactones, polyanhydrides, polyamides, polyurethanes, polyesteramides, polyorthoesters, polydioxanones, polyacetals, polyketals, polycarbonates, polyorthocarbonates, polyphosphazenes, polyhydroxybutyrates, polyhydroxyvalerates, polyalkylene oxalates, polyethylene oxides, polyacrylate/methacrylates, polyalkylene succinates, poly(malic acid) polymers, polymaleic anhydrides, poly(methylvinyl)ethers, poly(amino acids), chitin, chitosan, and copolymers, terpolymers, gutta percha, or mixtures thereof.

7. The obturator of claim 1 wherein the shaft material comprises the thermoplastic matrix material in the range from about 60 to about 70 weight percent; the filler in the range from about 30 to about 40 weight percent; and the process aid in the range from about 0.5 to about 2.0 weight percent.

8. The obturator of claim 1 wherein the shaft material further comprises polymeric resins, fillers, plasticizers, antibiotic, cariostatic, antibacterial, anti-inflammatory, biologically active, therapeutic materials, pigments, dyes and mixtures thereof.

9. The obturator of claim 1 comprising a range of sizes wherein the distal end ranges in diameter from about 0.10 mm to about 2.0 mm.

10. The obturator of claim 9 wherein the shaft is tapered from the distal end to the proximal end at a taper ranging from about 0.01 mm to about 0.10 mm.

11. The obturator of claim 1 wherein the filling material is applied to the shaft in a consistent, even layer.

12. The obturator of claim 1 wherein the shaft is fully dissolvable with a dental solvent.

13. The obturator of claim 1 wherein the shaft is partially dissolvable with a dental solvent.

14. The obturator of claim 1 wherein the dental solvent comprises chloroform, tetrahydrofuran, benzene, acetone, toluene, dichloromethane, N-methyl-2-pyrrolidone, dimethyl sulfoxide, acetone, hexafluoroisopropanol, limonene, eucalyptus oil, xylene, chlorinated hydrocarbons, aromatic hydrocarbons, or a mixture thereof.

15. A method of making an endodontic obturator comprising:
mixing a thermoplastic matrix material, a filler, and a process aid together to form a mixture, wherein the thermoplastic matrix material has a molding temperature greater than about 300° C. and a melting temperature in the range from about 150° C. to about 200° C.;
heating the mixture to a temperature in the range of about 285° C. to about 305° C.;
injection molding the heated mixture at a temperature in the range of about 335° C. to about 390° C. to form a shaft, whereby the shaft has a distal end and a proximal end; and
applying a filling material onto the shaft.

16. The method of claim 15 wherein the thermoplastic matrix material comprises polyamides, polyester, polyimides, polyarylates, polyurethanes, polysulfones, polyacetals, polycarbonates, polyphenylene sulfides, polyphenylene, polyarylsulfides, polyketones, polyphthalamide or mixtures thereof.

17. The method of claim 15 wherein the filler comprises one or more of apatites, silica glass fillers, calcium silicate based fillers, hydroxyapatites, barium sulfate, bismuth subcarbonate, bismuth oxychloride, ytterbium oxide, ytterbium fluoride, ytterbium iodine, bismuth oxide, bismuth trioxide, bismuth fluoride, barium oxide, tantalum oxide, zinc oxide and zirconium oxide.

18. The method of claim 15 wherein the process aid comprises a fatty acid, fatty alcohol, wax ester, glycerol ester, glycol ester, phosphate ester, hydrocarbon wax, fatty glyceride, unsaturated hydrocarbon, or a mixture thereof.

19. The method of claim 15 wherein the filling material comprises polylactides, polyglycolides, polycaprolactones, polyanhydrides, polyamides, polyurethanes, polyesteramides, polyorthoesters, polydioxanones, polyacetals, polyketals, polycarbonates, polyorthocarbonates, polyphosphazenes, polyhydroxybutyrates, polyhydroxyvalerates, polyalkylene oxalates, polyethylene oxides, polyacrylates/methacrylates, polyalkylene succinates, poly(malic acid) polymers, polymaleic anhydrides, poly(methylvinyl)ethers, poly(amino acids), chitin, chitosan, and copolymers, terpolymers, gutta percha, or mixtures thereof.

20. The method of claim 15 wherein the shaft material comprises the thermoplastic matrix material in the range from about 60 to about 70 weight percent; the filler in the range from about 30 to about 40 weight percent; and the process aid in the range from about 0.5 to about 2.0 weight percent.

21. The method of claim 15 wherein the shaft material further comprises polymeric resins, fillers, plasticizers, antibiotic, cariostatic, antibacterial, anti-inflammatory, biologically active, therapeutic materials, pigments, dyes and mixtures thereof.

22. The method of claim 15 further comprising molding the shaft having a diameter at the distal end in a range of sizes from about 0.10 mm to about 2.0 mm.

23. The method of claim 15 further comprising molding the shaft having a taper from the distal end to the proximal end wherein the taper ranges from about 0.01 mm to about 0.10 mm.

24. The method of claim 15 further comprising applying the filling material onto the shaft in a consistent, even layer.

25. The method of claim 15 wherein the shaft is dissolvable in a dental solvent.

26. The method of claim 25 wherein the dental solvent comprises chloroform,
tetrahydrofuran, benzene, acetone, toluene, dichloromethane, N-methyl-2-pyrrolidone, dimethyl sulfoxide, acetone, hexafluoroisopropanol, limonene, eucalyptus oil, xylene, chlorinated hydrocarbons, aromatic hydrocarbons, or a mixture thereof.
